(19) United States
(12) Patent Application Publication
(10) Pub. No.: US 2010/0279166 A1
(43) Pub. Date: Nov. 4, 2010

(54) HOT-SWAPPABLE AUXILIARY BATTERY MODULE, AUXILIARY SYSTEM AND HOT-SWAP METHOD

(76) Inventor: Chun-Hao Tseng, TAIPEI CITY (TW)

Correspondence Address: NORTH AMERICA INTELLECTUAL PROPERTY CORPORATION, P.O. BOX 506, MERRIFIELD, VA, 22116, US

(21) Appl. No.: 12/770,678

(22) Filed: Apr. 29, 2010

(30) Foreign Application Priority Data
Apr. 30, 2009 (TW) 098114462

(51) Int. Cl. H01M 10/02

(52) U.S. Cl. 429/123

(57) ABSTRACT

A hot-swappable auxiliary battery module, a hot-swappable auxiliary system and a hot-swap auxiliary method swap are provided. The hot-swappable auxiliary battery module is applied to an electronic device including a first battery, a battery connector, and a first power jack. The first battery is connected to the battery connector to provide power for the electronic device to operate. The hot-swappable auxiliary battery module includes a second battery and a power cable. The second battery is capable of being connected to the battery connector. One end of the power cable is capable of being connected with the first power jack, and the other end of the power cable is connected with the second battery to provide power to the electronic device, so that the operation of the electronic device continues when the first battery is disconnected from the battery connector.

### CROSS-REFERENCE TO RELATED APPLICATIONS

This Non-provisional application claims priority under 35 U.S.C. §119(a) on Patent Application No(s). 098114462 filed in Taiwan, Republic of China on Apr. 30, 2009, the entire contents of which are hereby incorporated by reference.

### BACKGROUND OF THE INVENTION

1. Field of the Invention

This invention relates to a battery module and, more particularly, to a hot-swappable auxiliary battery module, hot-swappable auxiliary system and hot-swap method.

2. Description of the Related Art

Batteries are used to provide power and maintain operation of a plurality of electronic devices, such as different kinds of handheld devices and so on. The capacity of the battery is limited. When power of the battery is exhausted, the battery needs to be replaced by a new one. For replacing the battery of the electronic device in an operating state, the called hot-swappable mechanism is generated.

Conventionally, in a hot-swap method of the battery, the following elements and executing steps are included. First, a backup battery pack unit with a full protection mechanism and less capacity is built in an electronic device. The backup battery generally may be a nickel-hydrogen battery, a lithium metal battery, a lithium ion battery, or a lithium macromolecule battery. In addition, the electronic device needs to connect a primary rechargeable battery pack unit with the full protection mechanism.

The backup battery may be rechargeable or may not be rechargeable. If the built-in backup battery is rechargeable, a charging circuit in the electronic device additionally needs a selector for respectively charging the backup battery and the primary battery. Thus, the circuit becomes complicated. In another aspect, if the backup battery is a lithium metal battery which cannot be rechargeable, a warning mechanism needs to be designed to allow a user to instantly replace the backup battery from the electronic device to prevent that a voltage of the battery is too low to achieve a dangerous value and cause explosion, firing, or burning.

According to the conventional method for achieving a hot-swap function by building the backup battery in the electronic device, no matter what kind of battery is used, a software and hardware design capable of supporting battery capacity detection of the primary battery and the backup battery is needed. If the backup battery is a lithium metal battery which cannot be rechargeable, the backup battery needs to be instantly replaced in the low value . That is, a mechanism facilitating disassembly needs to be additionally designed for the electronic device. Thus, the replacement of the battery and the risk of the battery may cause inconvenience for users. In another aspect, if the backup battery is a rechargeable nickel-hydrogen battery safer than the lithium battery, a plurality of the batteries with the lower voltage need to be in series to achieve the voltage of the lithium battery. Thus, the total volume of the batteries is larger, and the electronic device needs an additional space for containing the nickel-hydrogen battery. The charging mechanism of the nickel-hydrogen battery is different from that of the primary battery, i.e. the lithium battery. Thereby, the design of the charging circuit is complicated and cost is high.

According to the hot-swappable mechanism of the above method, the built-in backup battery has less capacity and fails to instantly provide high power for the electronic device to maintain normal operation of the electronic device. When the capacity of the primary battery is lower, the electronic device needs to enter into a sleep or hibernate mode thus to reduce the output power of the battery. That is, the primary battery remaining less capacity only can be taken out and be replaced by another primary battery with enough capacity after the electronic device enters into the sleep or hibernate mode. Then, the electronic device will be wakened to return to the normal operation mode for continuous operation.

### BRIEF SUMMARY OF THE INVENTION

The embodiment of the invention provides a hot-swappable auxiliary battery module, a hot-swappable auxiliary system and a hot-swap auxiliary method. In the invention, a battery can be replaced while an electronic device does not need to additionally have a built-in backup battery and does not need to enter into a low power consuming mode such as a sleep mode, that is, the electronic device is in normal operation.

The embodiment of the invention provides a hot-swappable auxiliary battery module applied to an electronic device including a first battery, a battery connector, and a first power jack. The first battery is connected to the battery connector to provide power for the electronic device to operate. The hot-swappable auxiliary battery module includes a second battery and a power cable. The second battery is capable of being connected to the battery connector. One end of the power cable is capable of being connected with the first power jack, and the other end of the power cable is connected with the second battery to provide power to the electronic device, so that the operation of the electronic device continues when the first battery is disconnected from the battery connector.

The embodiment of the invention also provides a hot-swappable auxiliary system including an electronic device, a second battery, and a power cable. The electronic device includes a first power jack, a battery connector, and a first battery. The first battery is connected to the battery connector to provide power for the electronic device to operate. The second battery is capable of being connected to the battery connector. One end of the power cable capable of being connected with the first power jack, and the other end of the power cable is connected with the second battery to provide power to the electronic device, such that the operation of the electronic device continues when the first battery is disconnected from the battery connector.

The embodiment of the invention also provides a hot-swap auxiliary method applied to an electronic device including a first battery and a battery connector. The first battery is connected to the battery connector to provide power for the electronic device to operate. The method includes the following steps. Connect one end of the power cable with the electronic device, and the other end is connected with the second battery to provide power to the electronic device via the power cable. Disconnect the first battery from the battery connector while the operation of the electronic device continues. The second battery is connected to the battery connector to provide power to the electronic device via the battery connector.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a hot-swappable auxiliary system according to a first embodiment of the invention;

FIG. 2 is a schematic diagram showing a hot-swappable auxiliary system according to a second embodiment of the invention;

FIG. 3 is a schematic diagram showing a hot-swappable auxiliary system according to one embodiment of the invention; and

FIG. 4 is a flowchart showing a hot-swap method for a battery according to one embodiment of the invention.

### DETAILED DESCRIPTION OF THE INVENTION

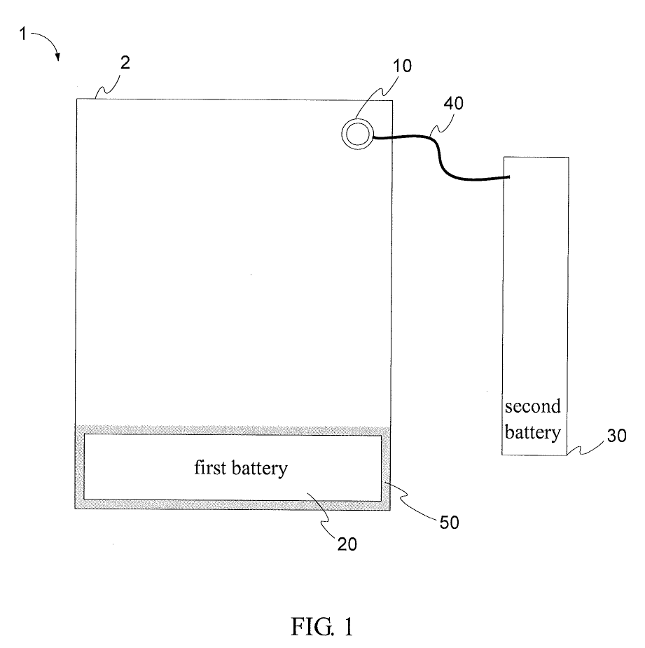

FIG. 1 is a schematic diagram showing a hot-swappable auxiliary system according to a first embodiment of the invention. In the embodiment of the invention, a hot-swappable auxiliary system 1 includes an electronic device 2, a second battery 30, and a power cable 40. The electronic device 1 includes a first power jack 10, a battery connector 50, and a first battery 20.

The first battery 20 is connected to the battery connector 50 of the electronic device 2 for providing power for the electronic device 2 to operate. In the embodiment, the electronic device 2 may be a notebook, a cellular phone, a smart phone, a GPS, a PDA, or other handheld devices. When the power of the first battery 20 is nearly exhausted thus to fail to maintain the operation of the electronic device 2, a hot-swap needs to be performed. That is, the first battery 20 in a lower capacity mode is replaced by the second battery 30. Thereby, the second battery 30 can be connected to the battery connector 50.

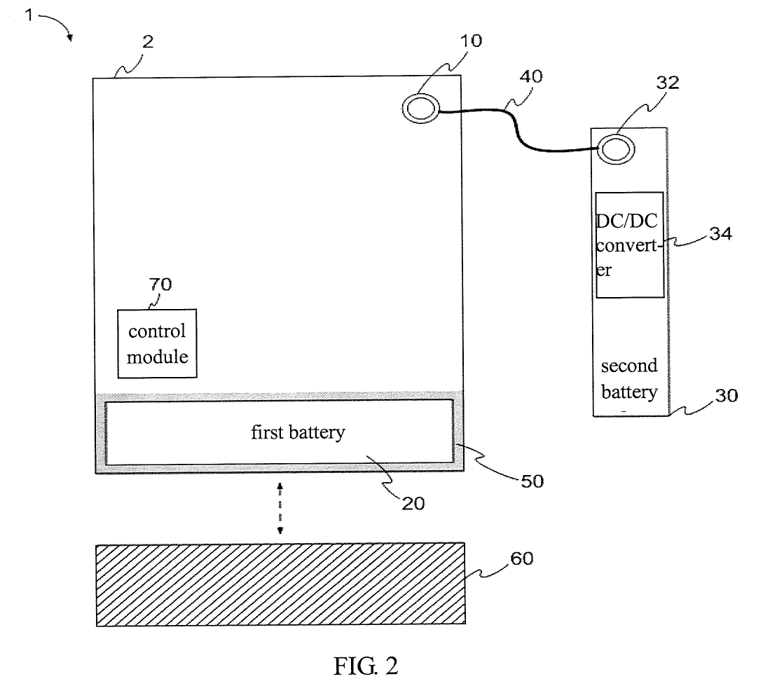

Generally, the electronic device 2 has a DC power jack, i.e. the called first power jack 10 in the embodiment of the invention, used for connecting an adapter, and the adapter can convert commercial power to DC voltage to provide power to the electronic device 2. The second battery 30 in the embodiment of the invention can have a second power jack 32 (as shown in FIG. 2). When the power of the first battery 20 is nearly exhausted, one end of the power cable 40 needs to be connected with the first power jack 10 of the electronic device 2, and the other end of the power cable 40 needs to be connected with the second battery 30. In one embodiment, the other end of the power cable 40 may be connected with the second power jack 32 to provide power to the electronic device 2 by the second battery 30.

In the embodiment, the capacity of the second battery 30 may be the same as that of the first battery 20. Therefore, when the power of the first battery 20 is not enough, and the first battery 20 is to be replaced by the second battery 30, the power cable 40 needs to connect the electronic device 2 and the second battery 30 first. When the electronic device 2 is still in the normal operation, the first battery 20 may be removed without affecting the normal operation of the electronic device 2. When the power cable 40 connects the electronic device 2 and the second battery 30, the second battery 30 provides the power for the electronic device 2.

FIG. 2 is a schematic diagram showing a hot-swappable auxiliary system according to a second embodiment of the invention. In the second embodiment, a second battery 30 includes a DC/DC converter 34, and an electronic device 2 further includes a battery cover 60 and a control module 70.

The electronic device 2 sometimes has a under voltage protection (UVP) function. That is, when an input voltage is too low, the under voltage protection function can prevent the low voltage from entering into the electronic device 2. For example, a general external adapter may provide a DC voltage of 19 V for the electronic device 2, and the electronic device 2 has a tolerated arrange from minus ten percent to plus ten percent. That is, when the input voltage is lower than 17 V, the under voltage protection function is started, such that the voltage lower than 17 V fails to be input into the electronic device 2. Therefore, to prevent the lower voltage provided by the second battery 30 (a voltage provided by a general battery is about 12 V) from failing to be input into the electronic device 2 by the under voltage protection function of the electronic device 2, the DC/DC converter 34 is additionally disposed in the second battery 30 for converting the voltage of the second battery 30. For example, an original voltage of 12 V may be boosted to 19 V to be supplied to the electronic device 2. In the same way, besides boosting the voltage, the DC/DC converter 34 of the second battery 30 may also be used for bucking voltage. The DC/DC converter 34 performs the different functions according to the voltage needed by the electronic device 2.

In addition, the DC/DC converter 34 of the second battery 30 may be enabled or disabled according to the following conditions. When a power cable 40 connects a first power jack 10 and the second battery 30, which indicates that the power of the first battery 20 is not enough, the second battery 30 is used to provide power to the electronic device 2. Thus, the DC/DC converter 34 is enabled in the above condition, and the second battery 30 temperately provides the power for the electronic device 2 via the power cable 40, which is called that a temporary power source function is started. In another aspect, when the first battery 20 is disconnected from the battery connector 50 and the second battery 30 replaces the first battery 20 to be connected to the battery connector 50, the DC/DC converter 34 of the second battery 30 is disabled thus to allow the second battery 30 to enter into a normal battery function. According to the above, when the first battery 20 is disconnected from the battery connector 50 and the second battery 30 is connected to the battery connector 50, the second battery 30 stops providing the power for the electronic device 2 via the power cable 40.

The first battery 20 and the second battery 30 may be a rechargeable battery, respectively. The electronic device 2 may be further connected with an external adapter. When the first battery 20 or the second battery 30 is connected with the electronic device 2, the external adapter provides the power for the electronic device 2, and also charges the battery connected to the battery connector 50. Thus, when the hot-swap of the battery is performed, the charging mechanism needs to be controlled. In one embodiment of the invention, the battery cover 60 and the control module 70 are in cooperation with each other to control the charging mechanism, which is described in detail hereinbelow.

The battery cover 60 is removably installed at the electronic device 2 for covering the first battery 20 connected to the battery connector 50. The control module 70 is used for detecting disassembly or assembly of the battery cover 60. When the battery cover 60 is disassembled from the electronic device 2, which indicates that the battery replacement is to be performed, the control module 70 disables the electronic device 2 from charging the first battery 20 via the battery connector 50. In another aspect, when the battery cover 60 is installed at the electronic device 2, which indicates that the battery is replaced or the battery of electronic device 2 still does not need to be replaced, the control module 70 enables the electronic device 2 to charge the first battery 20 via the battery connector 50. After the second battery 30 is connected with the battery connector 50, the second battery 30 can be used as the first battery 20. Therefore, only the first battery 20 is mentioned in the description about disabling or enabling the charging mechanism.

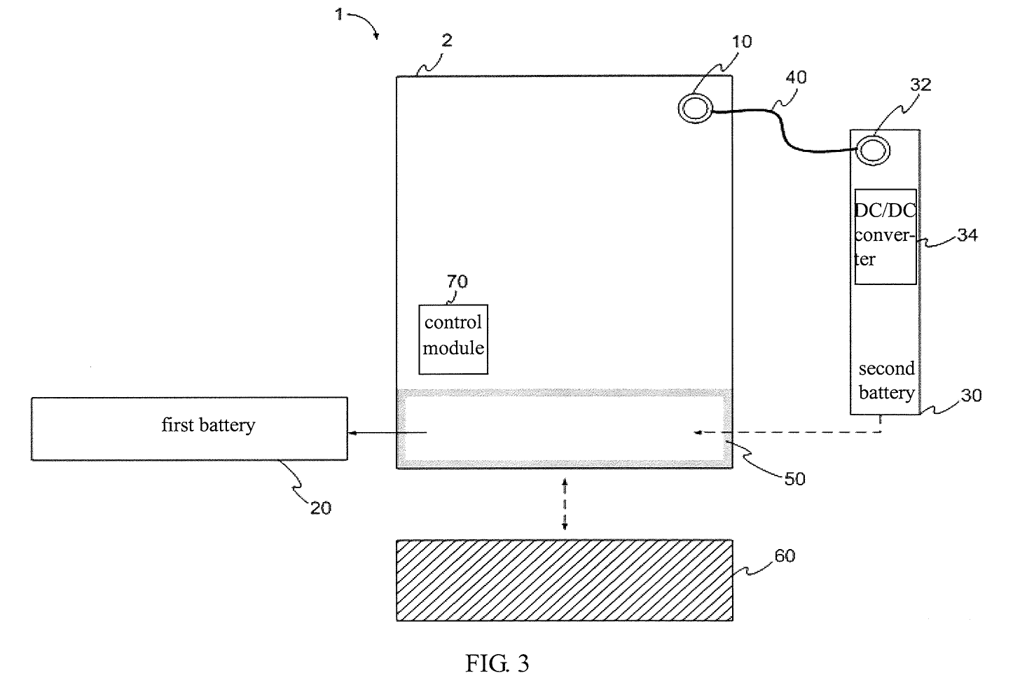

FIG. 3 is a schematic diagram showing a hot-swappable auxiliary system according to one embodiment of the invention. In the embodiment, a first battery 20 provides power needed by the operation of an electronic device 2. When the power of the first battery 20 is not enough and the first battery 20 is to be replaced, a battery cover 60 is first disassembled from the electronic device 2. At that moment, a control module 70 disables the electronic device 2 from charging the battery via the battery connector 50. Then, two ends of a power cable 40 are connected with a first power jack 10 of the electronic device 2 and a second power jack 32 of the second battery 30, respectively. Then, a DC/DC converter 34 of the second battery 30 is started. Thereby, the second batter 30 can temperately provide power to the electronic device 2 via the power cable 40. The first battery 20 is removed from the battery connector 50 while the electronic device 2 does not need to enter into a lower power-consuming mode such as a sleep or hibernate mode. That is, the battery can be replaced when the electronic device 2 is in the normal operation.

When the second battery 30 is connected to the battery connector 50, the DC/DC converter 34 of the second battery 30 is disabled, and the second battery 30 stops providing the power for the electronic device 2 via the power cable 40. At that moment, the second battery 30 formally provides the power for the electronic device 2. The power cable 40 can be removed, and the battery cover 60 can be installed at the electronic device 2 again. Further, the control module 70 can enable the electronic device 2 to charge the battery via the battery connector 50.

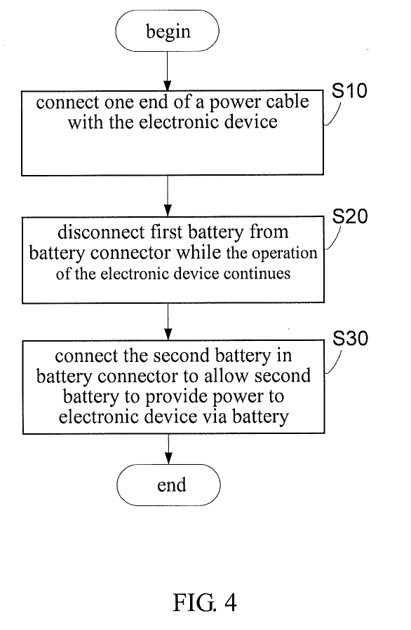

FIG. 4 is a flowchart showing a hot-swap auxiliary method according to one embodiment of the invention. The hot-swap auxiliary method is applied to an electronic device including a first battery and a battery connector. The first battery is connected to the battery connector to provide power for the electronic device to operate. The method includes the following steps.

Step S10: connect one end of a power cable with the electronic device. The other end of the power cable is connected with a second battery to provide power to the electronic device via the power cable.

Step S20: disconnect the first battery from the battery connector while the operation of the electronic device continues.

Step S30: connect the second battery in the battery connector to allow the second battery to provide power to the electronic device via the battery connector.

In step S10, voltage of the second battery can be converted, and then the power is provided for the electronic device via the power cable. Further, when the second battery is connected to the battery connector, the second battery stops providing the power for the electronic device via the power cable.

Besides the above steps, the method can include the following steps. A battery cover is removably installed at the electronic device for covering the first battery connected with the battery connector. Disassembly or assembly of the battery cover is detected. When the battery cover is disassembled from the electronic device, the electronic device is disabled from charging the first battery via the battery connector. When the battery cover is installed at the electronic device, the electronic device is enabled to charge the first battery via the battery connector.

In addition, after the first battery is replaced by the second battery and the second battery is connected to the battery connector, the power cable can be removed. The structure of the first battery may be the same as that of the second battery. Thereby, the first battery and the second battery may be alternatively used as the hot-swappable auxiliary battery module of the electronic device.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A hot-swappable auxiliary battery module for an electronic device, the electronic device including a first battery, a battery connector, and a first power jack, the first battery connected to the battery connector to provide power for the electronic device to operate, the hot-swappable auxiliary battery module comprising:
a second battery capable of being connected to the battery connector; and
a power cable, one end of the power cable being capable of being connected with the first power jack and the other end of the power cable being connected with the second battery to provide power to the electronic device, so that the operation of the electronic device continues when the first battery is disconnected from the battery connector.

2. The hot-swappable auxiliary battery module according to claim 1, wherein the first power jack is a DC power jack.

3. The hot-swappable auxiliary battery module according to claim 2, wherein the second battery comprises:
a DC/DC converter converting voltage of the second battery to provide power to the electronic device via the power cable.

4. The hot-swappable auxiliary battery module according to claim 3, wherein the DC/DC converter is enabled when the power cable connects the first power jack and the second battery.

5. The hot-swappable auxiliary battery module according to claim 3, wherein when the first battery is disconnected from the battery connector and the second battery is connected to the battery connector, the DC/DC converter is disabled.

6. The hot-swappable auxiliary battery module according to claim 1, wherein when the first battery is disconnected from the battery connector and the second battery is connected to the battery connector, the second battery stops providing the power for the electronic device via the power cable.

7. The hot-swappable auxiliary battery module according to claim 1, wherein the second battery comprises a second power jack, and the other end of the power cable is connected with the second power jack.

8. A hot-swappable auxiliary system comprising:
an electronic device including:
a first power jack;
a battery connector; and
a first battery connected to the battery connector to provide power for the electronic device to operate;
a second battery capable of being connected to the battery connector; and
a power cable, one end of the power cable being capable of being connected with the first power jack, the other end of the power cable being connected with the second battery to provide power to the electronic device, so that the operation of the electronic device continues when the first battery is disconnected from the battery connector.

9. The hot-swappable auxiliary system according to claim 8, wherein the first power jack is a DC power jack.

10. The hot-swappable auxiliary system according to claim 9, wherein the second battery comprises:
a DC/DC converter converting voltage of the second battery to provide power to the electronic device via the power cable.

11. The hot-swappable auxiliary system according to claim 10, wherein the DC/DC converter is enabled when the power cable connects the first power jack and the second battery.

12. The hot-swappable auxiliary system according to claim 10, wherein when the first battery is disconnected from the battery connector and the second battery is connected to the battery connector, the DC/DC converter is disabled.

13. The hot-swappable auxiliary system according to claim 8, wherein when the first battery is disconnected from the battery connector and the second battery is connected to the battery connector, the second battery stops providing the power for the electronic device via the power cable.

14. The hot-swappable auxiliary system according to claim 8, wherein the second battery comprises a second power jack, and the other end of the power cable is connected with the second power jack.

15. The hot-swappable auxiliary system according to claim 8, wherein the electronic device further comprises:
a battery cover removably installed at the electronic device for covering the first battery connected with the battery connector.

16. The hot-swappable auxiliary system according to claim 15, wherein the electronic device further comprises:
a control module detecting disassembly or assembly of the battery cover, when the battery cover is disassembled from the electronic device, the electronic device is disabled from charging the first battery via the battery connector, and when the battery cover is installed at the electronic device, the electronic device is enabled to charge the first battery via the battery connector.

17. A hot-swap auxiliary method applied to an electronic device including a first battery and a battery connector, the first battery connected to the battery connector to provide power for the electronic device to operate, the method comprising the following steps of:
connecting one end of a power cable with the electronic device, the other end of the power cable being connected with a second battery to provide power to the electronic device via the power cable;
disconnecting the first battery from the battery connector while the operation of the electronic device continues; and
connecting the second battery in the battery connector to provide power to the electronic device via the battery connector.

18. The hot-swap auxiliary method according to claim 17, wherein the step of providing the power for the electronic device via the power cable comprises the step of:
converting voltage of the second battery to provide power to the electronic device via the power cable.

19. The hot-swap auxiliary method according to claim 18, further comprising the following step of:
stopping providing the power for the electronic device via the power cable by the second battery when the second battery is connected to the battery connector.

20. The hot-swap auxiliary method according to claim 17, further comprising the following steps of:
removably installing a battery cover at the electronic device for covering the first battery connected with the battery connector;
detecting disassembly or assembly of the battery cover; and
disabling the electronic device from charging the first battery via the battery connector when the battery cover is disassembled from the electronic device, enabling the electronic device to charge the first battery via the battery connector when the battery cover is installed at the electronic device.

21. The hot-swap auxiliary method according to claim 17, further comprising the following step of:
removing the power cable when the second battery is connected to the battery connector.
